(19) United States
(12) Patent Application Publication
(10) Pub. No.: US 2024/0291949 A1
(43) Pub. Date: Aug. 29, 2024

(54) PROJECTOR AND CONTROL METHOD THEREOF

(71) Applicant: Coretronic Corporation, Hsin-Chu (TW)

(72) Inventors: Chien-Wei Wang, Hsin-Chu (TW); Chih-Lin Wang, Hsin-Chu (TW)

(73) Assignee: Coretronic Corporation, Hsin-Chu (TW)

(21) Appl. No.: 18/583,863

(22) Filed: Feb. 22, 2024

(30) Foreign Application Priority Data
Feb. 24, 2023 (CN) 202310161500.2

(51) Int. Cl. H04N 9/31; G06F 3/03

(52) U.S. Cl. CPC H04N 9/3185; G06F 3/0304

(57) ABSTRACT

A projector and a control method thereof are provided. The projector includes a sensor and a processor coupled to the sensor. The control method of a projector includes: measuring a distance between the sensor and an object through a sensor; and turning on or turning off a projector according to the distance and a threshold.

### CROSS-REFERENCE TO RELATED APPLICATION

This application claims the priority benefit of China application serial no. 202310161500.2, filed on Feb. 24, 2023. The entirety of the above-mentioned patent application is hereby incorporated by reference herein and made a part of this specification.

### BACKGROUND

### Technical Field

The disclosure relates to a projection technology, and in particular relates to a projector and a control method thereof.

### Description of Related Art

At present, turning on or off the projector by operating the remote control or the buttons on the projectors has many disadvantages. For example, when the projector is disposed at a high place, the user cannot turn on or turn off the projector by operating the buttons on the projector. In this way, if the remote controller of the projector is lost, the user is not be able to turn on or turn off the projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

A projector and a control method of the projector is provided in the disclosure.

The projector of the disclosure includes a sensor and a processor. The processor is coupled to the sensor, in which the processor is adapted for measuring a distance between the sensor and an object through the sensor, and turning on or turning off the projector according to the distance and a threshold.

A control method of a projector of the disclosure includes the following operation. A distance between a sensor and an object is measured through the sensor. The projector is turned on or turned off according to the distance and a threshold.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projector according to an embodiment of the disclosure.

FIG. 2A and FIG. 2B are flowcharts of a control method of a projector according to an embodiment of the disclosure.

FIG. 3 is a schematic diagram of a projector disposed in a cavity according to an embodiment of the disclosure.

FIG. 4 is a schematic diagram of a projector disposed in a cavity according to an embodiment of the disclosure.

FIG. 5 is a schematic diagram of a projector disposed in a cavity according to an embodiment of the disclosure.

FIG. 6 is a flowchart of a control method of a projector according to an embodiment of the disclosure.

### DETAILED DESCRIPTION OF DISCLOSED EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

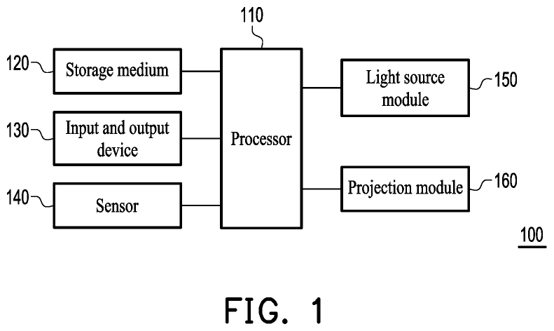

FIG. 1 is a schematic diagram of a projector 100 according to an embodiment of the disclosure. The projector 100 may include a processor 110, a storage medium 120, an input and output device 130, a sensor 140, a light source module 150, and a projection module 160. In one embodiment, the projector 100 may be placed in a cavity.

The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements, or a combination of the elements thereof. The processor 110 may be coupled to the storage medium 120, the input and output device 130, the sensor 140, the light source module 150, and the projection module 160, and the processor 110 may access and execute multiple modules and various applications stored in the storage medium 120 to implement various functions of the projector 100. The processor 110 may include one processor or several processors.

The storage medium 120 is, for example, any type of fixed or removable random access memory (RAM), read-only memory (ROM), flash memory, hard disk drive (HDD), solid state drive (SSD), or similar elements, or a combination of the elements thereof configured to store multiple modules or various applications executable by the processor 110.

The input and output device 130 may be configured to input (receive) or output signals. The user may operate the projector 100 through the input and output device 130. The processor 110 may output information through the input and output device 130 for user reference. The input and output device 130 may include but not limited to devices such as transceivers, keyboards, buttons, or touch screens. The user may operate the projector 100 through the input and output device 130 and an on-screen display (OSD) menu projected by the projector 100.

The sensor 140 is configured to measure the distance (e.g., distance value or an information related to the distance) between the sensor 140 and an object, in which the object is, for example, an inner wall of a cavity where the projector 100 is disposed or an object (e.g., a wall) outside the cavity. Since the projector 100 is disposed in the cavity, when the cavity is opened or closed, the distance measured by the sensor 140 may be different. Specifically, when the cavity is closed, the measured distance is the distance between the sensor 140 and the inner wall of the cavity. When the cavity is opened, the measured distance is the distance between the sensor 140 and the object outside the cavity.

In one embodiment, the sensor 140 is, for example, a time of flight (TOF) sensor. The sensor 140 may emit light to the object to measure the time of flight of the light between the sensor 140 and the object (the information related to the distance). After obtaining the time of flight of the light, the sensor 140 or the processor 110 may convert the time of flight into the distance (e.g., the sensor 140 measure the time of flight and transmit the time of flight data to the processor 110, or the sensor 140 measure and convert the time of flight into the distance and transmit the distance data to the processor 110). In one embodiment, the processor 110 may determine whether to turn on or turn off the projector 100 according to a threshold and the distance between the sensor 140 and the object. If the distance is greater than the threshold, the processor 110 turns on the projector 100 (e.g., power is supplied to the light source module 150 and the projection module 160 so that the projector 100 displays images). If the distance is less than or equal to the threshold, the processor 110 turns off the projector 100 (e.g., power supply to the light source module 150 and the projection module 160 is stopped so that the projector 100 stops displaying images).

The light source module 150 is configured to provide an illumination beam used by the projector 100 to project an image. The light source module 150 may include, for example, a light emitting device (e.g., Light Emitting Diode or Laser Diode), a lens or reflector for transmitting light beams, a dichroic element, a light combination element, a phosphor wheel, a filter wheel, or a homogenizing element. The projection module 160 may include a light valve and a projection lens, and the light valve may be a digital micromirror device (DMD), a liquid crystal display element, or a liquid-crystal-on-silicon panel (LCOS panel) and other elements capable of generating images. The projection module 160 is configured to modulate (convert) the illumination beam provided by the light source module 150 to form a modulated image (image beam) projected by the projector 100. The processor 110 may control the light source module 150 and the projection module 160 to display contents of multimedia files.

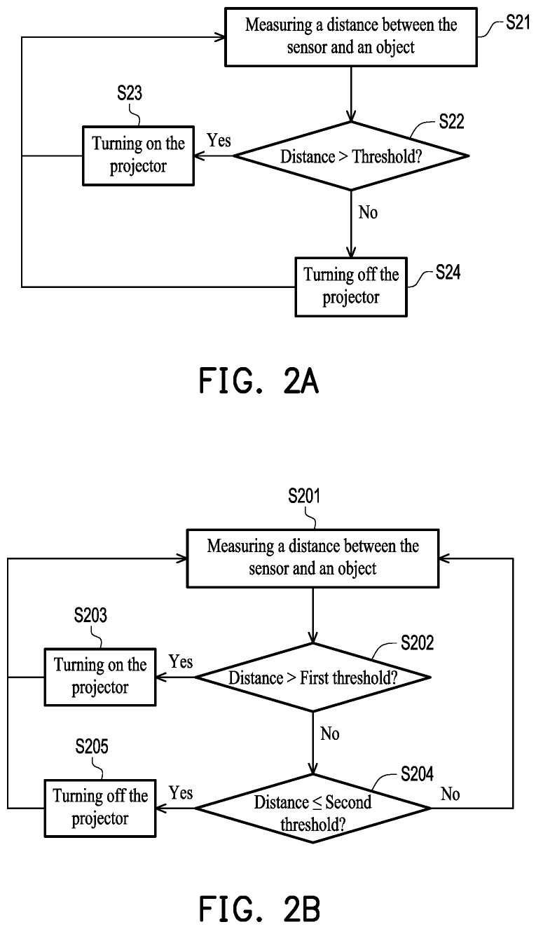

FIG. 2A and FIG. 2B are flowcharts of a control method of a projector according to an embodiment of the disclosure, in which the control method may be implemented by the projector 100 shown in FIG. 1, where the projector 100 may be disposed in a cavity.

Referring to FIG. 2A, in step S21, measuring the distance between the sensor 140 and an object through the sensor 140 (by the sensor 140 or the processor 110). For example, assuming that the sensor 140 is a time of flight sensor, the processor 110 may measure the time of flight through the sensor 140, thereby obtaining the distance derived from the time of flight. In one embodiment, the processor 110 may periodically measure the distance between the sensor 140 and the object through the sensor 140.
In step S22, the processor 110 may determine whether the measured distance is greater than the threshold. If the measured distance is greater than the threshold, go to step S23. If the measured distance is not greater than (less than or equal to) the threshold, go to step S24.
In step S23, the processor 110 may turn on the projector 100.
In step S24, the processor 110 may turn off the projector 100, or switch the projector 100 into sleep mode (e.g., power is supplied to the light source module 150 and/or the projection module 160, but the projector 100 doesn't display images).

Referring to FIG. 2B, in step S201, measuring the distance between the sensor 140 and an object through the sensor 140 (the processor 110 may obtain the distance between the sensor 140 and an object).
In step S202, the processor 110 may determine whether the measured distance is greater than a first threshold. If the measured distance is greater than the first threshold, go to step S203. If the measured distance is not greater than (less than or equal to) the first threshold, go to step S204.
In step S203, the processor 110 may turn on the projector 100.
In step S204, the processor 110 may determine whether the measured distance is less than or equal to a second threshold. If the measured distance is less than or equal to the second threshold, go to step S205. If the measured distance is not less than or equal to (greater than) the second threshold, re-execute step S201. The second threshold may be the same as or different from the first threshold. In one embodiment, the second threshold may be less than the first threshold. For example, the first threshold may be set to 2 meters, and the second threshold may be set to 50 centimeters.
In step S205, the processor 110 may turn off the projector 100, or switch the projector 100 into sleep mode.

The aforementioned threshold, first threshold, or second threshold may be pre-stored in the storage medium 120, or may be input to the projector 100 by the user via the input and output device 130. In one embodiment, the projector 100 may automatically generate the threshold, the first threshold, or the second threshold according to the environment.

Specifically, the processor 110 may receive a correction command via the input and output device 130 and enter a correction mode. In response to the correction command, the processor 110 may obtain the maximum value or the minimum value of the distance during a preset time period (e.g., 20 seconds) through the sensor 140 (the cavity is switched from open state to close state (close state to open state) during the preset time period, and the sensor 140 measure the time of flight several times during the preset time period). The processor 110 may generate the first threshold according to the maximum value of the distance, or may generate the second threshold according to the minimum value of the distance.

In one embodiment, the processor 110 may subtract an offset value from the maximum value of the distance during the preset time period to generate the first threshold. For example, it is assumed that the maximum value of the distance is 210 centimeters (cm). The processor 110 may subtract the offset value of 10 cm from 210 cm to generate the first threshold equal to 200 cm. In this way, the possibility of the projector 100 being turned on by mistake may be reduced.

In one embodiment, the processor 110 may add the offset value to the minimum value of the distance during the preset time period to generate the second threshold. For example, it is assumed that the minimum value of the distance is 45 cm. The processor 110 may add the offset value of 5 cm to the minimum value to generate the second threshold equal to 50 cm. In this way, the possibility of the projector 100 being turned off by mistake may be reduced.

In one embodiment, the processor 110 may determine whether the ratio between the maximum value and the minimum value of the distance is greater than a preset value. If the ratio is greater than the preset value, the processor 110 may determine that measuring the maximum value and minimum value of the distance is successful. Accordingly, the processor 110 may generate the first threshold according to the maximum value or may generate the second threshold according to the minimum value. On the other hand, if the ratio is less than or equal to the preset value, the processor 110 may determine that it fails to measure the maximum value and minimum value of the distance. Accordingly, the processor 110 does not automatically generate the first threshold or the second threshold according to the measurement result.

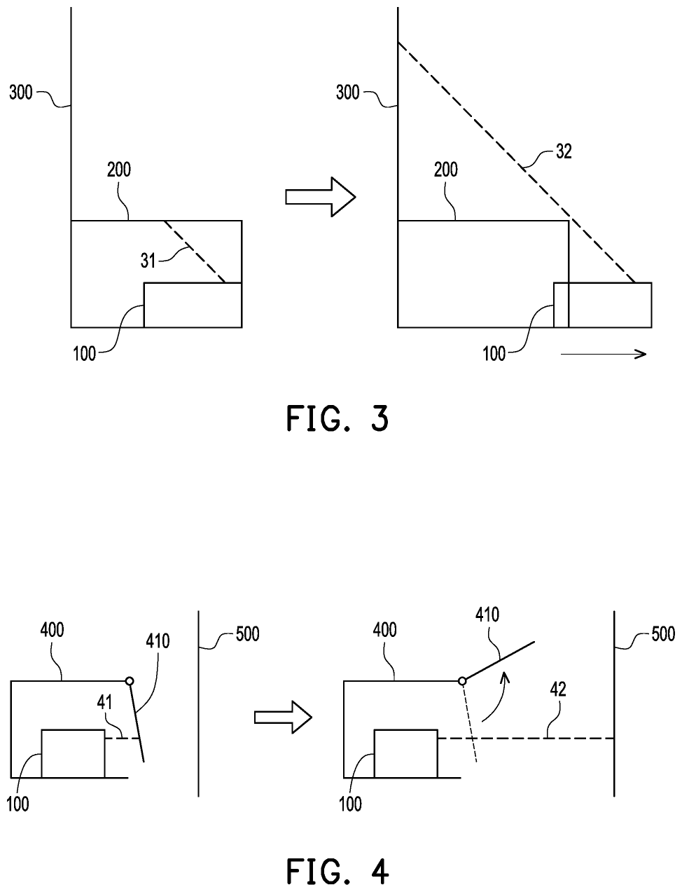

FIG. 3 is a schematic diagram of a projector 100 disposed in a cavity 200 according to an embodiment of the disclosure, in which the cavity 200 is, for example, a drawer cavity. When the drawer cavity is closed (the projector 100 is disposed on the drawer (or plate), and the drawer is located in the drawer cavity), the processor 110 of the projector 100 may measure the distance 31 between the sensor 140 and the inner wall of the cavity 200 through the sensor 140. When the drawer is opened (the drawer is pulled out of the drawer cavity), the processor 110 may measure the distance 32 between the sensor 140 and the wall 300 through the sensor 140.

In one embodiment, it is assumed that the processor 110 receives the correction command (i.e., the projector 100 is in the correction mode), and the distance 31 and the distance 32 are respectively the minimum value and the maximum value of the distance during the preset time period. The processor 110 may generate the second threshold according to the distance 31 and may generate the first threshold according to the distance 32. Specifically, the processor 110 may add the offset value to the distance 31 to generate the second threshold, or may subtract the offset value from the distance 32 to generate the first threshold.

In an embodiment, it is assumed that the processor 110 does not receive the correction command (i.e., the projector 100 is not in the correction mode). In response to the measured distance 31 being less than or equal to the second threshold, the processor 110 may turn off the projector 100, or in response to the measured distance 32 being greater than the first threshold, the processor 110 may turn on the projector 100.

FIG. 4 is a schematic diagram of a projector disposed in a cavity according to an embodiment of the disclosure, in which the cavity 400 is, for example, a cabinet with a flip cover 410. When the flip cover 410 is closed, the processor 110 of the projector 100 may measure the distance 41 between the sensor 140 and the inner wall of the cavity 400 through the sensor 140. When the flip cover 410 is opened, the processor 110 may measure the distance 42 between the sensor 140 and the wall 500 through the sensor 140.

In one embodiment, it is assumed that the processor 110 receives the correction command (i.e., the projector 100 is in the correction mode), and the distance 41 and the distance 42 are respectively the minimum value and the maximum value of the distance during the preset time period. The processor 110 may generate the second threshold according to the distance 41 and may generate the first threshold according to the distance 42. Specifically, the processor 110 may add the offset value to the distance 41 to generate the second threshold, or may subtract the offset value from the distance 42 to generate the first threshold.

In an embodiment, it is assumed that the processor 110 does not receive the correction command (i.e., the projector 100 is not in the correction mode). In response to the measured distance 41 being less than or equal to the second threshold, the processor 110 may turn off the projector 100, or in response to the measured distance 42 being greater than the first threshold, the processor 110 may turn on the projector 100.

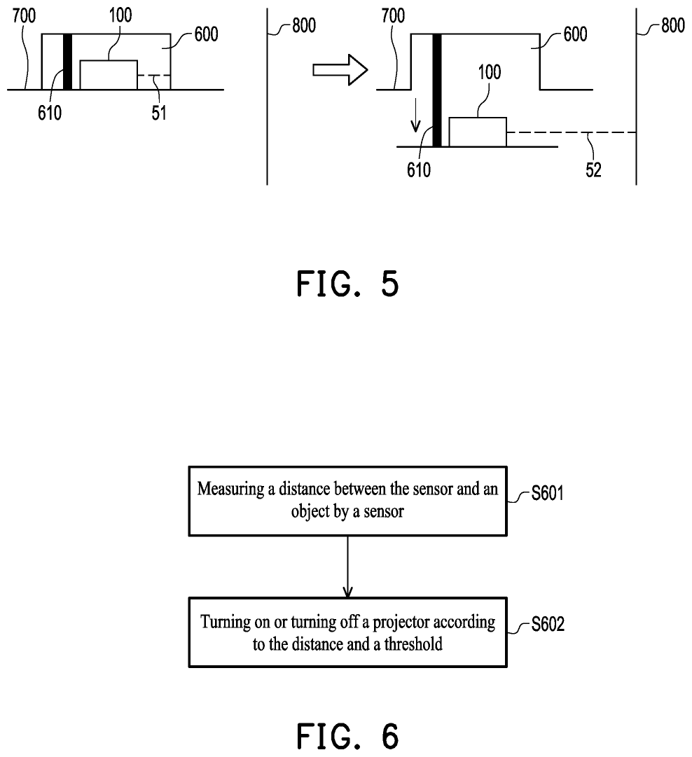

FIG. 5 is a schematic diagram of a projector 100 disposed in a cavity 600 according to an embodiment of the disclosure. The projector 100 may be disposed on the lifting platform 610. When the lifting platform 610 is raised, the lifting platform 610 may be hidden inside the cavity 600 located in the ceiling 700. The processor 110 of the projector 100 may measure the distance 51 between the sensor 140 and the inner wall of the cavity 600 through the sensor 140. When the lifting platform 610 is lowered, the lifting platform 610 may carry the projector 100 away from the cavity 600. The processor 110 may measure the distance 52 between the sensor 140 and the wall 800 through the sensor 140.

In an embodiment, it is assumed that the processor 110 receives the correction command (i.e., the projector 100 is in the correction mode), and the distance 51 and the distance 52 are respectively the minimum value and the maximum value of the distance measured by the sensor 140 during the preset time period. The processor 110 may generate the second threshold according to the distance 51 and may generate the first threshold according to the distance 52. Specifically, the processor 110 may add the offset value to the distance 51 to generate the second threshold, or may subtract the offset value from the distance 52 to generate the first threshold.

In an embodiment, it is assumed that the processor 110 does not receive the correction command (i.e., the projector 100 is not in the correction mode). In response to the measured distance 51 being less than or equal to the second threshold, the processor 110 may turn off the projector 100, or in response to the measured distance 52 being greater than the first threshold, the processor 110 may turn on the projector 100.

FIG. 6 is a flowchart of a control method of a projector according to an embodiment of the disclosure, in which the control method may be implemented by the projector 100 shown in FIG. 1. In step S601, measuring the distance between the sensor and the object through the sensor. In step S602, the projector is turned on or off according to the distance and the threshold.

To sum up, the turning on or turning off mechanism of the projector of the disclosure may be related to the cavity of the projector. When the cavity is opened, the projector may determine that the cavity has been opened according to the measurement result of the sensor, thereby determining that the user intends to use the projector. Accordingly, the projector may execute the turning on procedure. When the cavity is closed, the projector may determine that the cavity has been closed according to the measurement result of the sensor, thereby determining that the user no longer requires to use the projector. Accordingly, the projector may execute the turning off procedure. Through the control method of the disclosure, the projector may automatically execute the turning on procedure or the turning off procedure. Users are not required to use the buttons on the projector or the remote control to turn the projector on or off.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A projector, comprising:
a sensor; and
a processor, coupled to the sensor, wherein
the processor is adapted for obtaining a distance between the sensor and an object through the sensor, and turning on or turning off the projector according to the distance and a threshold.

2. The projector according to claim 1, wherein
in response to the distance being greater than the threshold, the processor turns on the projector, and in response to the distance being less than or equal to the threshold, the processor turns off the projector.

3. The projector according to claim 1, wherein
the threshold comprises a first threshold and a second threshold,
in response to the distance being greater than the first threshold, the processor turns on the projector, and in response to the distance being less than or equal to the second threshold, the processor turns off the projector, wherein the second threshold is less than the first threshold.

4. The projector according to claim 3, further comprising:
an input and output device, coupled to the processor, wherein
the processor is adapted for receiving a correction command via the input and output device, and in response to the correction command, measuring a maximum value of the distance during a preset time period through the sensor, wherein
the processor generates the first threshold according to the maximum value.

5. The projector according to claim 4, wherein
the processor is adapted for subtracting an offset value from the maximum value to generate the first threshold.

6. The projector according to claim 3, further comprising:
an input and output device, coupled to the processor, wherein
the processor is adapted for receiving a correction command via the input and output device, and in response to the correction command, measuring a minimum value of the distance during a preset time period through the sensor, wherein
the processor generates a second threshold according to the minimum value.

7. The projector according to claim 6, wherein
the processor is adapted for adding an offset value to the minimum value to generate the second threshold.

8. The projector according to claim 3, further comprising:
an input and output device, coupled to the processor, wherein
the processor is adapted for receiving a correction command via the input and output device, and in response to the correction command, measuring a maximum value and a minimum value of the distance during a preset time period through the sensor, wherein
in response to a ratio of the maximum value to the minimum value being greater than a preset value, the processor generates a first threshold according to the maximum value or generates a second threshold according to the minimum value.

9. The projector according to claim 1, wherein the projector is located in a cavity, and the object is an inner wall of the cavity.

10. A control method of a projector, comprising:
measuring a distance between a sensor and an object through the sensor; and
turning on or turning off the projector according to the distance and a threshold.

11. The control method of the projector according to claim 10, wherein turning on or turning off the projector according to the distance and the threshold comprises:
in response to the distance being greater than the threshold, turning on the projector, and in response to the distance being less than or equal to the threshold, turning off the projector.

12. The control method of the projector according to claim 10, wherein the threshold comprises a first threshold and a second threshold, wherein the control method further comprises:
in response to the distance being greater than the first threshold, turning on the projector; and
in response to the distance being less than or equal to the second threshold, turning off the projector, wherein the second threshold is less than the first threshold.

13. The control method of the projector according to claim 12, further comprising:
receiving a correction command via an input and output device, and in response to the correction command, measuring a maximum value of the distance during a preset time period through the sensor; and
generating the first threshold according to the maximum value.

14. The control method of the projector according to claim 13, wherein generating the first threshold according to the maximum value comprises:
subtracting an offset value from the maximum value to generate the first threshold.

15. The control method of the projector according to claim 12, further comprising:
receiving a correction command via an input and output device, and in response to the correction command, measuring a minimum value of the distance during a preset time period through the sensor; and
generating the second threshold according to the minimum value.

16. The control method of the projector according to claim 15, wherein generating the second threshold according to the minimum value comprises:
adding an offset value to the minimum value to generate the second threshold.

17. The control method of the projector according to claim 12, further comprising:
receiving a correction command via an input and output device, and in response to the correction command, measuring a maximum value and a minimum value of the distance during a preset time period through the sensor; and
in response to a ratio of the maximum value to the minimum value being greater than a preset value, generating the first threshold according to the maximum value or generating the second threshold according to the minimum value.

18. The control method of the projector according to claim 10, wherein the projector is located in a cavity, and the object is an inner wall of the cavity.
